(19) United States
(12) Patent Application Publication
(10) Pub. No.: US 2016/0086489 A1
(43) Pub. Date: Mar. 24, 2016

(54) E-BIKE TO INFRASTRUCTURE OR VEHICLE COMMUNICATION

(71) Applicant: Ford Global Technologies, LLC, Dearborn, MI (US)

(72) Inventors: Sudipto Aich, Palo Alto, CA (US); David Melcher, Ypsilanti, MI (US); Zachary David Nelson, Detroit, MI (US); Christopher Peplin, Ann Arbor, MI (US); Jamel Seagraves, Mountain View, CA (US)

(73) Assignee: Ford Global Technologies, LLC, Dearborn, MI (US)

(21) Appl. No.: 14/493,596

(22) Filed: Sep. 23, 2014

(51) Int. Cl. G08G 1/16; G08G 1/0967

(52) U.S. Cl. CPC G08G 1/166; G08G 1/096791

(57) ABSTRACT

An electric bicycle includes a communication module and a computing device. The communication module receives vehicle information indicating a trajectory of a vehicle. The computing device compares the vehicle information to bicycle information, which represents a trajectory of a bicycle. The communication module wirelessly transmits the bicycle information to the vehicle associated with the vehicle information. A method includes generating an alert signal if the vehicle is predicted to collide with the bicycle.

### BACKGROUND

Bicycles are generally more maneuverable than most automobiles. Because of this, bicycles are becoming increasingly popular in dense urban areas. Some cities have dedicated bicycle lanes to encourage and facilitate bicycle traffic in especially crowded areas.

### BRIEF DESCRIPTION OF THE DRAWINGS

FIG. 1 illustrates an example electric bicycle configured to generate an alert indicating a possible collision with a vehicle.

FIG. 2 is a block diagram of an example system that may be incorporated into the electric bicycle of FIG. 1.

FIG. 3 illustrates an example vehicle that can communicate with an electric bicycle.

FIG. 4 is a flowchart of an example process that may be executed by the electric bicycle to attempt to avoid a potential collision with a vehicle.

FIG. 5 is a flowchart of an example process that may be executed by the target vehicle to attempt to avoid a potential collision with a bicycle having the system of FIG. 2.

### DETAILED DESCRIPTION

While bicycles have the advantage of maneuverability in urban areas, the bicycle's speed, agility, and relatively small size can make it difficult for the bicycle to be noticed by a driver or even a collision avoidance system. In congested areas, many drivers and collision avoidance systems look for much larger vehicles like cars, trucks, and buses. Moreover, a bicycle can easily enter into the path of a vehicle in the time it takes for the driver to check his or her blind spot and begin to maneuver the vehicle. Bicycle riders, therefore, must be constantly vigilant to avoid such threats.

One way to help vehicle and bicycle riders avoid collisions is to alert the driver and rider of the potential collision. An example bicycle that can help avoid such collisions includes a communication module and a computing device. The communication module receives vehicle information indicating a trajectory of a vehicle such as a car, truck, or bus. The computing device compares the vehicle information to bicycle information, which represents a trajectory of the bicycle. The communication module wirelessly transmits the bicycle information to the vehicle associated with the vehicle information. An alert signal is generated if the vehicle and bicycle are predicted to collide with one another. The alert signal may include an audible alert, a visual alert, or a haptic alert, and may be provided to the rider of the bicycle, the driver of the vehicle, or both. Thus, the alert signal may direct the driver or rider to immediately stop or change course to avoid the potential collision.

In addition to collision avoidance, the system disclosed may provide opportunities for cooperative traffic management with regard to bicyclists and motorists, especially in dense urban environments. Moreover, the system could be used to route motor vehicle traffic away from (and bicycle traffic toward) common bicycle routes.

The elements shown may take many different forms and include multiple and/or alternate components and facilities. The example components illustrated are not intended to be limiting. Indeed, additional or alternative components and/or implementations may be used.

As illustrated in FIG. 1, the bicycle 100 may be an electric bicycle with an electric motor 105 powered by a power source 110, such as a battery. The power source 110 may provide the electric motor 105 with an electric change. In response, the electric motor 105 may rotate. The rotation of the electric motor 105 may drive the wheels, propelling the bicycle 100.

The bicycle 100 may further include a system 115 for determining whether the bicycle 100 is about to collide with a vehicle, and if so, alerting the rider of the bicycle 100, the driver of the vehicle, or both. For instance, the system 115 may compare a trajectory of the vehicle to the trajectory of the bicycle 100. Based on the trajectories, the system 115 can determine whether the bicycle 100 and vehicle are likely to collide. If so, the system 115 may alert the rider of the bicycle 100, the driver of the vehicle, or both, of the predicted collision so that the collision can be avoided.

Although an electric bicycle 100 is shown in FIG. 1 and the term “bicycle” is used throughout, the system 115 may be incorporated into may other types of vehicles such as a human-powered bicycle, such as a bicycle with pedals, a motorcycle, a tricycle, a quadricycle, etc.

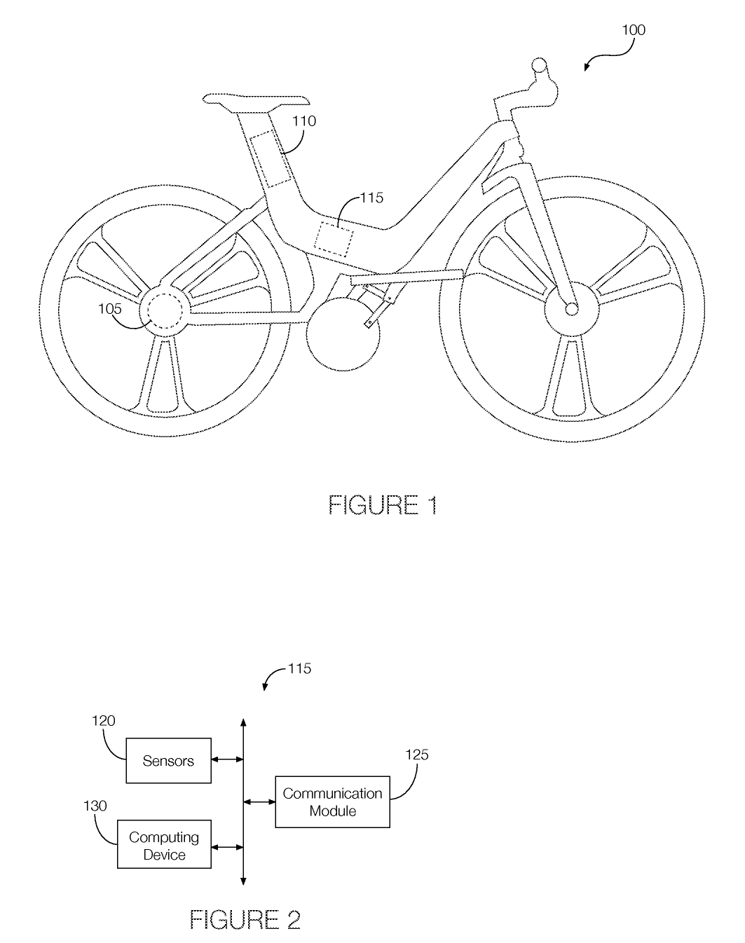

FIG. 2 is a block diagram of an example system 115 that may be used with the bicycle 100 of FIG. 1 to, e.g., alert the rider of the bicycle 100, the driver of the vehicle, or both, of a potential collision. The system 115, as shown, includes one or more sensors 120, a communication module 125, and a computing device 130.

The sensors 120 may be configured to collect bicycle information. Examples of bicycle information may include the speed of the bicycle 100, the direction of the bicycle 100, the position of the bicycle 100, a brake pressure, whether the bicycle 100 is upright, etc. Accordingly, the sensor may include a speedometer, a location system such as a Global Positioning System (GPS), a navigation system, a gyroscope, etc. The sensors 120 may be configured to output signals representing the bicycle information. In one possible implementation, the sensors 120 may be incorporated into a mobile device such as a mobile phone or tablet computer. Alternatively or in addition, one or more of the sensors 120 may be disposed on or embedded in the frame of the bicycle 100.

The communication module 125 may be configured to wirelessly communicate using any telecommunications protocol such as the dedicated short range communication (DSRC) protocol, WiFi, Bluetooth®, or the like. Therefore, the communication module 125 may be configured to communicate with automobiles such as cars, trucks, and buses, infrastructure devices, or other bicycles. The communication module 125 may be configured to transmit, for instance, the bicycle information collected by the sensors 120. Additionally, the communication module 125 may be configured to receive vehicle information, which may represent, e.g., a trajectory of a vehicle near the bicycle 100 (referred to as a “target vehicle”). The vehicle information may be received from the target vehicle or from another bicycle, another vehicle, or an infrastructure device able to receive vehicle information from the target vehicle.

The computing device 130 may be configured to process various sets of data. For example, the computing device 130 may be configured to process the bicycle information and predict the trajectory of the bicycle 100 from the bicycle information. Moreover, the computing device 130 may be configured to process vehicle information received from, e.g., a target vehicle. The computing device 130 may be configured to compare the bicycle information to the vehicle information to determine whether the bicycle 100 and target vehicle are likely to collide. That is, the computing device 130 may compare the trajectory of both the bicycle 100 and the vehicle.

If the current trajectories of the bicycle 100 and vehicle indicate that the bicycle 100 and vehicle will intersect within the next few seconds, the computing device 130 may be configured to generate and output an alert signal. The alert signal, therefore, may indicate a potential collision to both the rider of the bicycle 100 and the driver of the vehicle. The alert signal may include any combination of audible, visible, or haptic alerts. Some alerts may be provided via, e.g., a user interface device, lights, or speakers mounted on the bicycle 100 or a rider's mobile device. Haptic alerts may be further or alternatively provided via, e.g., the handlebars or seat. The alert signal may be transmitted to the target vehicle so that a similar alert may be provided to the driver of the vehicle.

Concerning bicycle-to-infrastructure communication, the system 115 incorporated into or otherwise used by the bicycle 100 may be configured to determine and alert the rider to the location of various points of interest. By way of example, the system 115 may be programmed to alert the rider of the bicycle if a charging location is nearby. The system 115 may determine whether a charging location is nearby based on signals received from an infrastructure device.

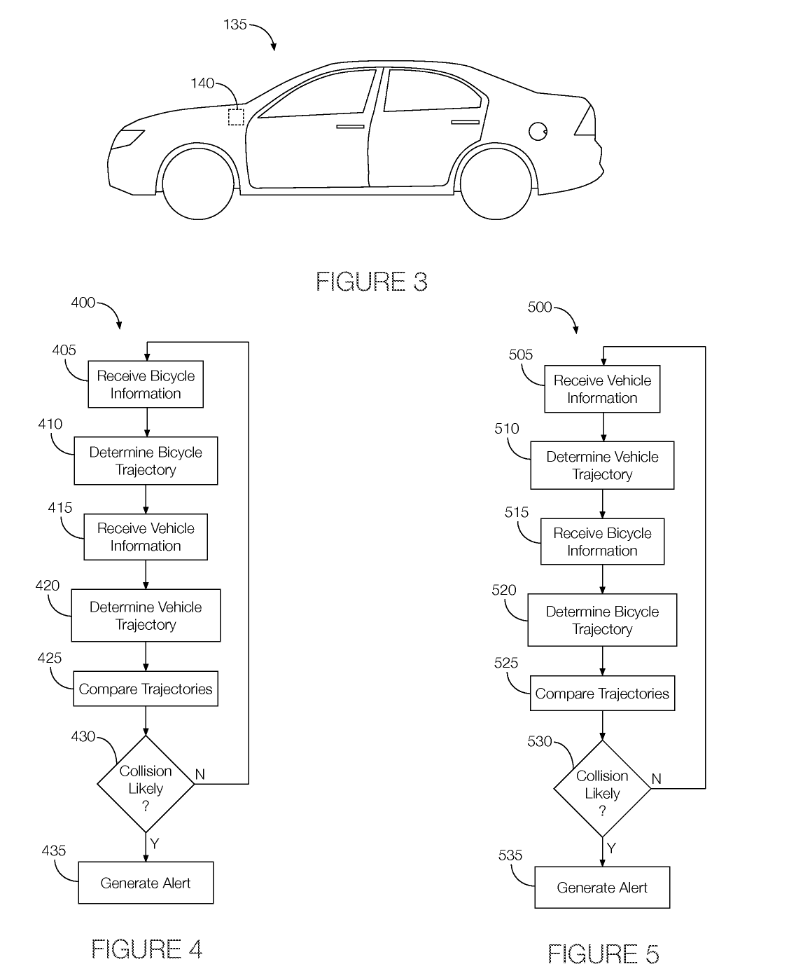

Referring now to FIG. 3, an example target vehicle 135 may include a system 140 configured to transmit vehicle information and receive bicycle information or the alert signal from a nearby bicycle 100 or infrastructure device. The system 140 incorporated into the vehicle 135 may operate similarly to the system 115 described above with regard to FIGS. 1 and 2. That is, the system 140 incorporated into the vehicle 135 may be configured to wirelessly communicate with nearby bicycles, infrastructure devices, and possibly other vehicles. The system 140 may determine, based on the trajectory of the vehicle 135 and the bicycle 100, whether a collision is likely to occur. If so, the system 140 may output an alert signal to the driver. In some instances, the system 140 may wirelessly communicate the alert signal to the bicycle 100. In the vehicle 135, the alert may be provided to the driver via, e.g., a user interface device such as a head-up display (HUD), the instrument panel, the steering wheel, a touch-screen display, or the like. As with the alert provided to the rider of the bicycle 100, the alert provided to the driver may include an audible, visible, or haptic alert.

The vehicle information transmitted by the system 140 in the vehicle 135 may include the speed of the vehicle 135, the direction of the vehicle 135, the position of the vehicle 135, a brake pressure, etc. This vehicle information may be collected by one or more on-board vehicle sensors including a speedometer, a location system such as a Global Positioning System (GPS), and a navigation system, among others.

Moreover, the output of the vehicle system 140 may provide additional information about bicycle traffic beyond alerting the driver of the vehicle 135 of a potential collision. For example, the vehicle system 140 may present, via, e.g., a user interface device or head-up display (HUD), a map of bicycles 100 near the vehicle 135. The map may alert the driver of the vehicle 135 to locations where bicycle traffic is especially heavy, and a navigation system on-board the vehicle 135 may be programmed to route the vehicle 135 away from such bicycle traffic.

Further, although illustrated as a sedan, the vehicle 135 may include any passenger or commercial vehicle such as a car, a truck, a sport utility vehicle, a taxi, a bus, etc. In some possible approaches, the vehicle 135 is an autonomous vehicle configured to operate in an autonomous (e.g., driverless) mode, a partially autonomous mode, and/or a non-autonomous mode.

FIG. 4 is a flowchart of an example process 400 that may be executed by the electric bicycle 100 to attempt to avoid a potential collision with the vehicle 135. The process 400 may be executed by one or more components of the system 115 used by the bicycle 100. A similar process may be executed by the system 140 incorporated into the target vehicle 135, which is discussed below with reference to FIG. 5.

At block 405, the system 115 may receive bicycle information. The bicycle information may be collected by one or more sensors 120 on-board the bicycle 100 or on a mobile device such as a cell phone. The bicycle information may be communicated from one or more sensors 120 to the computing device 130. Moreover, the bicycle information may be wirelessly communicated, by the communication module 125, to nearby vehicles, infrastructure devices, or both.

At block 410, the system 115 may determine a trajectory of the bicycle 100 from the bicycle information. The trajectory may be determined by, e.g., the computing device 130. To determine the trajectory, the computing device 130 may consider factors such as the speed of the bicycle 100, the direction of the bicycle 100, and the current location of the bicycle 100.

At block 415, the system 115 may receive vehicle information. The vehicle information may be transmitted from, e.g., a nearby vehicle or infrastructure device and may represent the trajectory of the target vehicle 135. The bicycle 100 may receive the vehicle information via, e.g., the communication module 125. Once received, the communication module 125 may communicate the vehicle information to the computing device 130.

At block 420, the system 115 may determine the trajectory of the target vehicle 135. That is, the computing device 130 may estimate the trajectory from the vehicle information received at block 415.

At block 425, the system 115 may compare the trajectory of the target vehicle 135 to the trajectory of the bicycle 100. For instance, the computing device 130 may compare the two trajectories to determine whether the target vehicle 135 is likely to collide with the bicycle 100 within a predetermined amount of time. An example predetermined amount of time may be on the order of 3 to 5 seconds or any other amount of time sufficient for the system 115 to generate the alert at block 435 and for the driver of the target vehicle 135 or the rider of the bicycle 100 to make a maneuver to avoid the collision.

At decision block 430, the system 115 may determine whether a collision is likely. The computing device 130 may make such a determination based on the comparison performed at block 425. If the computing device 130 determines that a collision is likely, the process 400 may continue at block 435. Otherwise, the process 400 may return to block 405.

At block 435, the system 115 may generate the alert signal. The alert signal may be generated by the computing device 130 and output to warn the rider of the bicycle 100 of the potential collision. The alert provided to the rider may include an audible, visible, or haptic alert. Some alerts may be provided via, e.g., a user interface device, lights, or speakers mounted on the bicycle 100 or a rider's mobile device. Haptic alerts may be further or alternatively provided via, e.g., the handlebars or seat.

The process 400 may continue at block 405 after the alert is generated.

FIG. 5 is a flowchart of an example process 500 that may be executed by the target vehicle 135 to attempt to avoid a potential collision with the bicycle 100 having the system 115 shown in FIG. 2. The process 500 may be executed by one or more components of the system 140 used by the vehicle 135.

At block 505, the system 140 may receive vehicle information collected by one or more on-board vehicle sensors. Moreover, the vehicle information may be wirelessly communicated to nearby bicycles, other vehicles, or infrastructure devices.

At block 510, the system 140 may determine a trajectory of the vehicle 135 from the vehicle information. To determine the trajectory, the system 140 may consider factors such as the speed of the vehicle 135, the direction of the vehicle 135, and the current location of the vehicle 135 (e.g., whether the vehicle 135 is on a one-way road, whether the vehicle 135 is at an intersection, whether the vehicle 135 is subject to a traffic control device, etc.).

At block 515, the system 140 may receive bicycle information. The bicycle information may be transmitted from, e.g., a nearby vehicle, bicycle, or infrastructure device and may represent the trajectory of the bicycle 100.

At block 520, the system 140 may determine the trajectory of the bicycle 100. The trajectory may be estimated from the bicycle information received at block 515.

At block 525, the system 140 may compare the trajectory of the target vehicle 135 to the trajectory of the bicycle 100. This comparison may indicate whether the target vehicle 135 is likely to collide with the bicycle 100 within a predetermined amount of time. An example predetermined amount of time may be on the order of 3 to 5 seconds or any other amount of time sufficient for the system 140 to generate the alert at block 535 and for the driver of the target vehicle 135 or the rider of the bicycle 100 to make a maneuver to avoid the collision.

At decision block 530, the system 140 may determine whether a collision is likely from the comparison of the trajectories at block 525. If the system 140 determines that a collision is likely, the process 500 may continue at block 535. Otherwise, the process 500 may return to block 505.

At block 535, the system 140 may generate the alert signal. The alert signal may be output to warn the driver of the target vehicle 135 of the potential collision. In the target vehicle 135, the alert may be provided to the driver via, e.g., a user interface device such as a head-up display (HUD), the instrument panel, the steering wheel, a touch-screen display, or the like. As with the alert provided to the rider of the bicycle 100, the alert provided to the driver may include an audible, visible, or haptic alert.

The process 500 may continue at block 505 after the alert is generated.

In general, the computing systems and/or devices described may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An electric bicycle comprising:
a communication module configured to receive vehicle information; and
a computing device configured to compare the vehicle information to bicycle information, wherein the vehicle information indicates a vehicle trajectory and the bicycle information indicates a bicycle trajectory, and
wherein the communication module is configured to wirelessly transmit the bicycle information to a vehicle associated with the vehicle information.

2. The electric bicycle of claim 1, wherein the communication module is configured to transmit the bicycle information to the vehicle.

3. The electric bicycle of claim 1, wherein the communication module is configured to transmit the bicycle information to an infrastructure device.

4. The electric bicycle of claim 1, wherein the communication module is configured to receive the vehicle information from at least one of the vehicle and an infrastructure device.

5. The electric bicycle of claim 1, wherein the computing device is configured to generate an alert signal.

6. The electric bicycle of claim 5, wherein the alert signal indicates a potential collision with the vehicle.

7. The electric bicycle of claim 5, wherein the alert signal includes at least one of an audible alert, a visible alert, and a haptic alert.

8. The electric bicycle of claim 5, wherein the alert signal is transmitted to the vehicle.

9. The electric bicycle of claim 1, wherein the bicycle information includes at least one of a speed, a brake pressure, a direction, and a location.

10. The electric bicycle of claim 1, wherein the vehicle information includes at least one of a speed, a brake pressure, a direction, and a location.

11. A method comprising:
receiving bicycle information;
determining a trajectory of a bicycle from the bicycle information;
receiving vehicle information;
determining a trajectory of a vehicle from the vehicle information;
comparing the trajectory of the bicycle to the trajectory of the vehicle;
generating an alert signal if the vehicle is predicted to collide with the bicycle.

12. The method of claim 11, further comprising wirelessly transmitting the bicycle information to the vehicle.

13. The method of claim 11, further comprising wirelessly transmitting the bicycle information to an infrastructure device.

14. The method of claim 11, wherein the vehicle information is received from at least one of the vehicle and an infrastructure device.

15. The method of claim 11, wherein the alert signal indicates a potential collision with the vehicle.

16. The method of claim 11, wherein the alert signal includes at least one of an audible alert, a visible alert, and a haptic alert.

17. The method of claim 11, wherein the alert signal is transmitted to the vehicle.

18. The method of claim 11, wherein the bicycle information includes at least one of a speed, a brake pressure, a direction, and a location.

19. The method of claim 11, wherein the vehicle information includes at least one of a speed, a brake pressure, a direction, and a location.

20. A vehicle system comprising:
a communication module configured to receive bicycle information; and
a computing device configured to compare the bicycle information to vehicle information, wherein the bicycle information indicates a bicycle trajectory and the vehicle information indicates a vehicle trajectory, and
wherein the communication module is configured to wirelessly transmit the vehicle information to a bicycle associated with the bicycle information.
